(19) United States
(12) Patent Application Publication
(10) Pub. No.: US 2009/0085360 A1
(43) Pub. Date: Apr. 2, 2009

(54) OUTER DOOR HANDLE FOR AUTOMOTIVE VEHICLES

(75) Inventor: Angelo Bertolotti, Turin (IT)

Correspondence Address: LOWE HAUPTMAN HAM & BERNER, LLP, 1700 DIAGONAL ROAD, SUITE 300, ALEXANDRIA, VA, 22314, US

(73) Assignee: ITW Automotive Products GmbH & Co., KG, Iserlohn (DE)

(21) Appl. No.: 12/293,114

(22) PCT Filed: Mar. 30, 2007
(86) PCT No.: PCT/IB2007/000844

§ 371 Date: Sep. 16, 2008

(30) Foreign Application Priority Data
Jun. 17, 2006 (DE) 10 2006 027 912.3

(51) Int. Cl. E05B 65/20

(52) U.S. Cl. 292/336.3

(57) ABSTRACT

An automobile outer door handle, comprising a lever-shaped handle portion which is manually gripped from the door's outer side and which is fitted with at least one bearing element resting in pivotably manner on a mating bearing element of the door and is coupled by a linkage to a door lock in a manner that, when this lock shall open when the handle portion is pivoted out of a rest position into an open position, an inertial mass being supported in excursion-limited manner in the region of the swivel bearing of the handle portion in a similar direction as the handle portion, said inertial mass locking in one limit position (blocked position) the handle portion into the rest position whereas releasing it in the other limit position (release position) and being moved into the blocked position when a predetermined transverse acceleration acts on the automobile to exert an opening force on the handle portion.

The present invention relates to an automobile outside door handle defined in claim 1.

Most automobile outside door handles are mounted in an automobile body recess, which will be entered by the fingers of a hand to pivot outward a lever-like door handle portion. The handle portion is appropriately pivotably supported rests in the door. The handle portion is connected by a linkage to a door lock which shall be opened when this handle portion is pivoted outward, whereby the door may be moved into its open position.

There are numerous accidents where the automobile is impacted sideways. In such an impact, the automobile is accelerated transversely, the said handle portion by inertia tending to remain in position while the vehicle abruptly changes its position. In this manner an opening force is applied to the handle portion and hence on the door lock, raising the danger the door shall burst open.

The objective of the present invention is to create an automobile outer door handle precluding door opening even when high accelerations are applied to said automobile.

This objective is attained by means of the features of claim 1.

In the outer handle of the present invention, a inertial mass is supported in displaceable manner within given limits in the region of the handle portion's swivel bearing and approximately in the same direction as the handle portion. The inertial mass is displaceable between two limit positions, namely a blocking position wherein the handle portion is locked in its rest position and a release position wherein said handle portion is allowed to pivot. The inertial mass is mechanically biased (prestressed) toward the release position. The inertial mass moves into its blocked position when a predetermined transverse acceleration is applied to the automobile and exerts an opening force on the handle portion.

The inertial mass used in the invention may be relatively small, being merely required to permit moving it during a transverse acceleration against its mechanical bias into its blocked position wherein it then locks the handle portion or a bearing element thereof in position. Accordingly the means to implement locking the outer door handle in this manner are very simple. Again the automobile weight is only minimally raised by such an inertial mass even when four-door vehicles are equipped with one inertial mass at each door handle.

The mechanical bias of the inertial mass into the release position can be implemented by gravity. In one embodiment mode of the present invention, the inertial mass is spring-biased.

Conceptually the inertial mass may be displaced rectilinearly. Preferably however the inertial mass shall be displaced pivotably between the release and blocked positions. In a special embodiment mode of the latter feature, the inertial mass rests pivotably about a pivot pin at the bearing element, said axis being parallel approximately to that axis about which the bearing element is supported about the mating bearing element. The inertial mass comprises a blocking element spaced from its pivot pin, said blocking element cooperating—when the inertial mass is in its blocked position—with a blocking surface of the mating bearing element. Illustratively said blocking surface may be in the form of a recess in the mating bearing element. Accordingly, in the present invention, said inertial mass assumes the form of a single-arm lever or a pendulum, the center of gravity of such a component being a distance from its pivot axis.

In a further embodiment mode of the present invention, the inertial mass is fitted with a rest element situated on the side of the pivot pin opposite the blocking element, said rest element being biased by said biasing spring against stop surface of mating bearing element in a manner that, upon the handle portion being pivoted into the open position, the inertial mass shall be pivoted toward the release position. The last described design ensures that the handle portion may be freely pivoted under ordinary circumstances without said inertial mass becoming a blocking means.

Various designs are conceivable to reduce the present invention to practice. One approach calls for the handle portion comprising two horizontally spaced mating support arms. One of these support elements comprises two parallel apart support arms receiving between them one mating support arm, the inertial mass resting in pivotable manner on the end zone of a support arm.

The invention is elucidated below by an illustrative embodiment shown in the appended drawings.

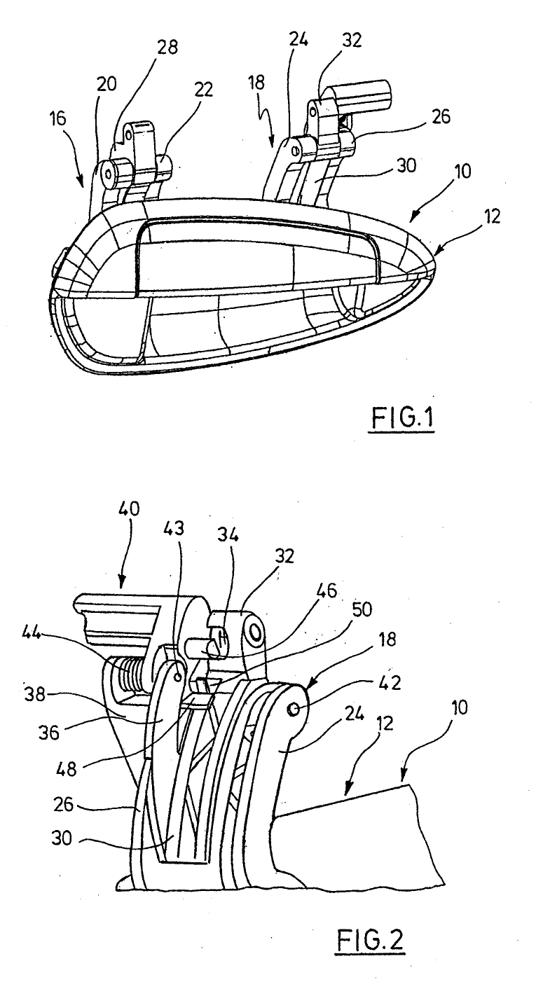

FIG. 1 is a perspective of an outer door handle of the invention, and

FIG. 2 is a perspective of an applicable locking means for the outer door handle of FIG. 1 as seen from the side opposite to that of FIG. 1.

FIGS. 1 and 2 show an outer door handle denoted overall by 10. For simplicity, the associated door of the automobile is omitted. The outer door handle comprises a handle portion 12 accessible externally from the door and allowing gripping it in order to pivot it from a rest position shown in FIG. 1 into an open position, the pivoting motion relating to FIG. 1 being toward the viewer of FIG. 1

Seen from the rear side of the handle portion 12, there are two support arms which comprise two arm elements 20, 22 and 24, 26 respectively, configured in fork-like manner. Mating support arms 28, 30 are mounted between the arm elements 20, 22 and 24, 26 respectively. As a result and using an omitted spindle, the support arms 16, 18 rest on the mating support arms 28, 30 in pivotable manner about a common pin which optionally may run approximately horizontally. In a manner not shown in detail here, the mating support arms 28, 30 are rigidly affixed to the automobile door.

As shown by FIG. 2, the mating support arm comprises an upward extension 32 fitted with a locking recess 34. A further support arm 36 is integral with the support arm 26 and, jointly with a support element 38, constitutes a bearing for the inertial mass 40. Overall said inertial mass is L-shaped, one leg of this L resting on a pivot pin parallel to the support pin of the support arms 24, 26 at the mating support arm 30. Said pivot pin is indicated at 43. A helical spring 44 is mounted on said pivot pin and biases the inertial mass 40 in the counter-clockwise direction (as seen in FIG. 2). The operative mass is housed in the other leg of the L-shaped inertial mass 40. An axially parallel blocking element 46 in the form of a cross-sectionally semi-circular protrusion is integrated into the bearing leg of the inertial mass 40 and is situated at the level of the recess 34. A rest element 48 is constituted in the end zone of the bearing leg on the side of the bearing pin 43 of the inertial mass that is opposite the protrusion 46, said rest element 48 coming to rest against the facing side of the mating support arm 30 when the biasing spring 44 is able to prestress the inertial mass 40 in counterclockwise manner. A triangular protrusion 50 is constituted at the mating support arm 30 behind the rest element 48 of FIG. 2, and projects by a given height the rest element 48.

The design described above operates as follows. The handle portion 12 is pivoted clockwise about the bearing pin 42 when the handle would be released. As a consequence the rest element 48 would lift off the mating rest arm 30 if the spring 44 would not rotate the inertial mass counter-clockwise to an extent that the rest element 48 would be adjusted toward said mating rest arm 30, whereby the protrusion 50 by its facing surface also engages the rest element 48. In this manner the opening displacement of the handle portion 12 precludes the blocking element 46 engaging the recess 34. If that had been the case, the handle portion 12 could not have been rotated farther.

Now if following transverse acceleration an opening force does act on the handle portion 12, it would be pivoted into the open position. However the inertial mass 40 in the present case shall be pivoted clockwise against the force of the spring 44, the blocking element 46 moves into the blocking recess 34 whereby the handle portion 12 is locked into its rest position and cannot reach the open position. As soon as the transverse acceleration has dropped below a predetermined value, the inertial mass 40 is returned into its release position.

As already mentioned above, the configuration of the outer door handle in this outer door is not shown in further detail. Moreover the linkage connecting to the door lock also was omitted. Such components are widely known and therefore need not be discussed further.

1. An automobile outer door handle comprising a lever-like handle portion which is manually gripped from the door outside, further at least one bearing element resting pivotably on a mating bearing element of such a door and coupled by a linkage to a door lock in a manner that said lock shall be opened when said handle portion is pivoted outward into an open position,
characterized
in that an inertial mass is supported in the region of the swivel bearing of the handle portion so as to be approximately pivotably displaceable within a limited excursion in the same direction as the handle portion, said inertial mass in one of its limit positions (blocking position) locking the handle portion into the rest position and in the other limit position (release position) releasing said handle portion, in that the inertial mass is mechanically biased (loaded) and is displaced into the blocked position when a predetermined transverse acceleration acts on the automobile and applies an opening force on the handle portion.

2. Outer door handle as claimed in claim 1, characterized in that the inertial mass is biased by a spring toward and into the release position.

3. Outer door handle as claimed in claim 1, characterized in that the inertial mass rests on the bearing element in pivotable manner about a pivot pin running approximately parallel about the pivot pin about which the bearing element is supported on the mating bearing element and in that the inertial mass comprises a blocking element spaced from the pivot pin and cooperating—in the blocked position of the inertial mass—with a blocking surface of the mating bearing element.

4. Outer door handle as claimed in claim 3, characterized in that the blocking surface is constituted by a recess of the mating bearing element.

5. An outer door handle as claimed in claim 2, characterized in that, on the side of the pivot pin opposite the blocking element, the inertial mass comprises a rest element which when biased by the bias ring rests against a stop surface of the mating bearing element in such manner that when the handle portion is pivoted into the open position, the inertial mass shall be pivoted toward the release position.

6. Outer door handle as claimed in claim 2, characterized in that the handle portion comprises two horizontally spaced-apart bearing elements cooperating with mating support arms of mating bearing elements, one of the bearing elements being fitted with two parallel and mutually apart support arms receiving between them a mating support arm, and the inertial mass being pivotably supported in the end zone of one support arm.
